(19) United States
(12) Patent Application Publication
(10) Pub. No.: US 2004/0121122 A1
(43) Pub. Date: Jun. 24, 2004

(54) Carbonaceous coatings on flexible graphite materials

(75) Inventors: Robert A. Reynolds III, Bay Village, OH (US); Mehmet Suha Yazici, Parma Heights, OH (US)

Correspondence Address: MELISSA A. CARR, ADVANCED ENERGY TECHNOLOGY INC., 12900 SNOW ROAD, PARMA, OH, 44130, US

(73) Assignee: Graftech, Inc., Wilmington, DE

(21) Appl. No.: 10/326,464

(22) Filed: Dec. 20, 2002

(51) Int. Cl. B32B 3/10

(52) U.S. Cl. 428/137; 428/166; 428/408

(57) ABSTRACT

A flexible graphite sheet having a hydrophobic binder and a carbonaceous material adhered thereto is disclosed. The flexible graphite sheet may be used as an electrode or a gas diffusion layer in a fuel cell, such as a proton exchange membrane fuel cell. Fuel cells having such a flexible graphite sheet and methods for making such flexible graphite sheets are also disclosed.

### BACKGROUND

1. Field of the Invention

The present invention relates to flexible graphite materials with carbonaceous coatings and to the uses of such materials. One specific embodiment of the present invention relates to the use of such materials as electrodes or gas diffusion layers in fuel cells.

2. Technical Background

Fuel cells can be used to convert energy from one form to another and have a wide variety of applications, including in the aerospace, automotive, and electronics industries. One type of fuel cell is an ion exchange membrane fuel cell, also known as a proton exchange membrane fuel cell, a polymer electrolyte membrane fuel cell or a solid polymer electrolyte fuel cell, hereinafter referred to as a “PEM fuel cell”. Other types of fuels cells include reformate/air fuel cells, direct methanol fuel cells (which use methanol as fuel), regenerative fuel cells, alkaline fuel cells, phosphoric acid fuel cells, solid oxide fuel cells, zinc air fuel cells, protonic ceramic fuel cells, and molten carbonate fuel cells. The general design of most fuel cells is similar except for the electrolyte, and, possibly, the specific fuel.

A PEM fuel cell produces electricity through the chemical reaction of hydrogen and oxygen in the air. Within the fuel cell, electrodes denoted as anodes and cathodes surround a polymer electrolyte to form what is generally referred to as a membrane electrode assembly, or an MEA. Often, the electrodes also function as the gas diffusion layer (or GDL) of the fuel cell. A catalyst material stimulates hydrogen molecules to split into protons and electrons and then, at the membrane, the protons pass through the membrane and the electrons flow through an external circuit. The electrons are utilized as electrical energy. The protons migrate through the electrolyte and combine with oxygen and electrons to form water.

A PEM fuel cell includes a membrane electrode assembly sandwiched between two flow field plates. Conventionally, the membrane electrode assembly includes random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which join with the protons coming through the proton exchange membrane and the electrons through the circuit, and combine to form water. Since the membrane is an electrical insulator, the electrons travel through an external circuit in which the electricity is utilized, and join with protons at the cathode. Combinations of such fuel cells are used in a fuel cell stack to provide the desired voltage.

The flow field plates have a continuous reactant flow channel with an inlet and an outlet. The inlet is connected to a source of fuel in the case of an anode flow field plate, or a source of oxidant in the case of a cathode flow field plate. When assembled in a fuel cell stack, each flow field plate functions as a current collector.

Electrodes, also sometimes referred to as gas diffusion layers, may be formed by providing a graphite sheet and providing the sheet with channels, which are typically smooth-sided, and which pass between the parallel, opposed surfaces of the flexible graphite sheet and are separated by walls of compressed expandable graphite. When a graphite sheet functions as an electrode, it is the walls of the graphite sheet that actually abut the ion exchange membrane.

The channels are formed in the flexible graphite sheet at a plurality of locations. A pattern of channels is typically formed in the flexible graphite sheet. That pattern can be devised in order to control, optimize or maximize fluid flow through the channels, as desired. For instance, the pattern formed in the flexible graphite sheet can comprise selective placement of the channels, as described, or it can comprise variations in channel density or channel shape in order to, for instance, equalize fluid pressure along the surface of the electrode when in use, as well as for other purposes which would be apparent to the skilled artisan.

The impact force is preferably delivered using a patterned roller, suitably controlled to provide well-formed perforations in the graphite sheet. In the course of impacting the flexible graphite sheet to form channels, graphite is displaced within the sheet to disrupt and deform the parallel orientation of the expanded graphite particles. In effect the displaced graphite is being “die-molded” by the sides of adjacent protrusions and the smooth surface of the roller. This can reduce the anisotropy in the flexible graphite sheet and thus increase the electrical and thermal conductivity of the sheet in the direction transverse to the opposed surfaces. A similar effect is achieved with frusto-conical and parallel-sided peg-shaped flat-ended protrusions.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and, thus, exhibit or possess many properties that are highly directional, e.g. thermal and electrical conductivity and fluid diffusion.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to as “flexible graphite”).

In addition to flexibility, the expanded graphite sheet material has also been found to possess a high degree of anisotropy with respect to thermal and electrical conductivity and fluid diffusion, comparable to the natural graphite starting material due to orientation of the expanded graphite particles and graphite layers substantially parallel to the opposed faces of the sheet resulting from very high compression, e.g. roll pressing. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

Returning to the fuel cells, current PEM fuel cell designs use a humidified gas stream containing oxygen on the oxygen or cathode side, and sometimes the gas stream containing hydrogen on the hydrogen or fuel side is humidified, to prevent the dryout of the membrane. Dryout of the membrane may lead to failure of the membrane and the fuel cell. As the reactions in the fuel cell occur, water is produced, as described above. This water is typically removed from the fuel cell by the gas stream containing oxygen. As this gas stream becomes saturated, it becomes unable to remove the water generated by the reaction and water may then accumulate in the porous of a gas diffusion layer. This may result in blocking the transport of oxygen to the membrane and is known as “flooding.” To ensure proper operation of the fuel cell, a balance between keeping the membrane too dry and too wet must be established.

If the accumulation of water becomes excessive, then one or more of the channels of the gas diffusion layer may become blocked, sometimes referred to as “liquid holdup.” It is then possible that the blocked channels result in a marked reduction of flow of the oxygen-containing gas. This reduction in flow of the oxygen-containing gas reduces the amount of reactant available to react with the proton and reduces the ability of the oxygen containing gas to remove the generated water from the fuel cell. The present invention addresses the above shortcomings in the art.

### SUMMARY OF THE INVENTION

Accordingly, one embodiment of the present invention is to provide improved graphite articles and processes for making the same.

Another embodiment of the present invention is to provide improved gas diffusion layers and processes for preparing the same.

Still another embodiment of the present invention is to provide improved proton exchange membrane fuel cells, and processes for preparing the same.

These and other embodiments , which will be apparent to those skilled in the art after reading this specification, are achieved by the development of a novel graphite article and a novel process for making graphite articles. The novel graphite article includes: a compressed mass of expanded graphite particles in the form of a sheet having opposed major surfaces, a hydrophobic polymeric binder on one of said major surfaces, and a carbonaceous material in contact with said polymeric binder on said one major surface. The novel process for making graphite articles includes the steps of: adding a carbonaceous material to a hydrophobic polymeric binder to form a mixture; and applying the mixture to a major surface of a flexible graphite substrate to form a coated graphite substrate. The method may optionally include sintering the coated graphite substrate to form a flexible graphite sheet having adhered carbonaceous material.

The graphite materials and processes of the present invention have a number of uses that will be apparent to those skilled in the art after reading this specification. One example of such a use is in the making of a gas diffusion layer for a fuel cell. Such a gas diffusion layer has a number of advantages, examples of which include: improved water management within the fuel cell, the ability to produce thinner gas diffusion layers, the ability to avoid the use of carbon paper as part of the gas diffusion layer, and the ability to incorporate the polymeric binder into the flexible graphite sheet, thereby increasing the adhesion between the carbonaceous material and the flexible graphite sheet.

In addition to the above, the gas diffusion layers of the present invention have excellent thermal and electrical conductivity as compared to carbon paper, carbon cloth, or carbon felt based gas diffusion layers; improved ability to control the macroporosity of the gas diffusion layer; and superior corrosion resistance as compared to metal containing gas diffusion layers.

Another advantage of practicing the present invention is that a fuel cell made with the novel gas diffusion layers described herein may operate without dehydrating the membrane of the fuel cell. Additionally, the novel gas diffusion layers have better strength than the conventional gas diffusion layers, and exhibit improved durability. The invention may also be used to improve the homogeneity of the dispersion of the carbonaceous material on the flexible graphite gas diffusion layer.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

### BRIEF DESCRIPTION OF THE DRAWING

FIG. 1 is an exploded side view of a fuel cell in accordance with one specific embodiment of the present invention;

FIG. 2 is a representational view of a gas diffusion layer with a carbonaceous coating in accordance with one specific embodiment of the present invention; and

FIG. 3 is a detailed view of the portion of FIG. 2 identified by the letter “A”.

### DETAILED DESCRIPTION OF THE INVENTION

The present invention includes providing source materials such as flexible sheets of graphite material. The source materials typically comprise graphite, a crystalline form of carbon comprising atoms covalently bonded in flat layered planes with weaker bonds between the planes. In obtaining source materials such as the above flexible sheets of graphite, particles of graphite, such as natural graphite flake, are typically treated with an intercalant of, e.g. a solution of sulfuric and nitric acid, the crystal structure of the graphite reacts to form a compound of graphite and the intercalant. The treated particles of graphite are hereafter referred to as “particles of intercalated graphite.”

Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are, therefore, commonly referred to as worms. The worms may be compressed together into flexible sheets that, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials typically have a degree of graphitization of about 1.0. As used in this disclosure, the term “degree of graphitization” refers to the value “g” according to the formula:

g=3.45−d(002)0.095

where d(002) is the spacing between the graphitic layers of the carbons in the crystal structure measured in Angstrom units. The spacing “d” between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the flexible sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite typically has an ash content of less than twenty weight percent. For some uses, the graphite employed for the present invention will need to have a purity of at least about 94%. In other uses, the graphite employed will need to have a purity of at least about 99%.

One method for manufacturing graphite sheet is described by Shane, et al. in U.S. Pat. No. 3,404,061, the disclosure of which is incorporated herein by reference. In the typical practice of the Shane, et al. method, natural graphite flakes are intercalated by dispersing the flakes in a solution containing, e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In one preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. In certain specific embodiments, organic materials of this type that contain carbon, hydrogen and oxygen, preferably exclusively, are employed.

Carboxylic acids have been found especially effective as an expansion aid. A suitable carboxylic acid useful for this purpose include: aromatic, aliphatic or cycloaliphatic, straight chain or branched chain, saturated and unsaturated monocarboxylic acids, dicarboxylic acids and polycarboxylic acids. These carboxylic acids typically have at least 1 carbon atom, and more typically up to about 15 carbon atoms. Moreover, these carboxylic acids need to be soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH2)nCOOH wherein “n” is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative examples of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative examples of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative examples of alkyl esters are dimethyl oxylate and diethyl oxylate. Representative examples of cycloaliphatic acids are cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative examples of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution is typically aqueous and will typically contain an amount of expansion aid of from about 1 to 10%, the amount being effective to enhance exfoliation. In an embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures typically in the range of 25° to 125° C. to promote reaction of the reducing agent and intercalant coating. The heating period is typically up to about 20 hours, with shorter heating periods, e.g., at least about 10 minutes, for higher temperatures in the above-noted range.

The thus treated particles of graphite are sometimes referred to as “particles of intercalated graphite” or “expandable graphite.” Upon exposure to high temperature, e.g. temperatures of at least about 160° C. and especially about 700° C. to 1200° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.05 mm to 4.00 mm and a typical density of about 0.1 to 1.5 grams per cubic centimeter (g/cc). From about 1 to 30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.1 to 2.0 millimeters. The width of the particles is suitably from about 0.05 to 0.001 mm.

The ceramic fiber particles are non-reactive and non-adhering to graphite and are stable at temperatures up to about 1100° C., typically about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also be treated with resin. This treatment enhances the moisture resistance and handling strength, i.e. stiffness, of the flexible graphite sheet as well as “fixing” the morphology of the sheet. Suitable resin content is typically at least about 5% by weight, more typically about 10 to 35% by weight, and suitably up to about 60% by weight. Resins found especially useful in the practice of the present invention include acrylic-, epoxy- and phenolic-based resin systems, or mixtures thereof. Suitable epoxy resin systems include those based on diglycidyl ether or bisphenol A (DGEBA) and other multifunctional resin systems. Phenolic resins that can be employed include resole and novolac phenolics.

The graphite sheet of the present invention can be cut and trimmed to form the desired articles. The methods of the present invention may use the above-described graphite sheets including the trimmed portions. More specifically, the process of the present invention may use the above-described graphite sheets including the trimmed portions at various stages of completeness, as discussed below.

In the present invention, it has been found that adhesion with a hydrophobic binder of carbonaceous materials to the flexible graphite sheet used as an electrode or a GDL improves removal of the water and allows continued flow of the gas stream. While the following discussion is in terms of the GDLs, it is also applicable to electrodes. Application of carbonaceous material to the gas diffusion layer provides water management for any water that would migrate to the GDL.

It has been determined that adhering carbonaceous material to gas diffusion layers in fuel cells provides for improved management of the water generated by the reactions within the fuel cells and an increase in fuel cell efficiency for at least the reason of less “clogging” of gas flow paths that supply the fuel or oxygen to a catalyst layer of the fuel cell. The adherent carbonaceous material with a hydrophobic binder (may also be referred to as a non-wetting binder) forms a porous layer typically having porosity of between about 20% and about 80%. The porous layer has micro and macro channels therein. Typically, the carbonaceous material has an electrical conductivity of greater than the electrical conductivity of soot. Soot is defined herein as a material consisting essential of carbon particles chiefly formed from incomplete combustion of burning material.

The use of “carbonaceous material” herein means material containing or yielding carbon. Examples of suitable carbonaceous materials include Vulcan carbon, carbon nanofibers, graphite nanofibers, graphite, carbon nanotubes, carbon fibers, graphite fibers, carbon black, activated carbon, and combinations thereof. The definition of the term hydrophobic is used herein in accordance with a common definition of term hydrophobic in any scientific reference. Examples of suitable hydrophobic binders include, but are not limited to, polyvinyldiene fluoride and polytetrafluoroethylene. “Porosity” as used herein means the ratio of the volume of the voids of a material to the volume of its mass.

While the present invention will be described in terms of a preferred embodiment relating to PEM fuel cells, the invention is not limited thereto. The description in terms of PEM fuel cells is exemplary and intended to describe the invention and enable its practice, without being limited to the particular fuel cell described.

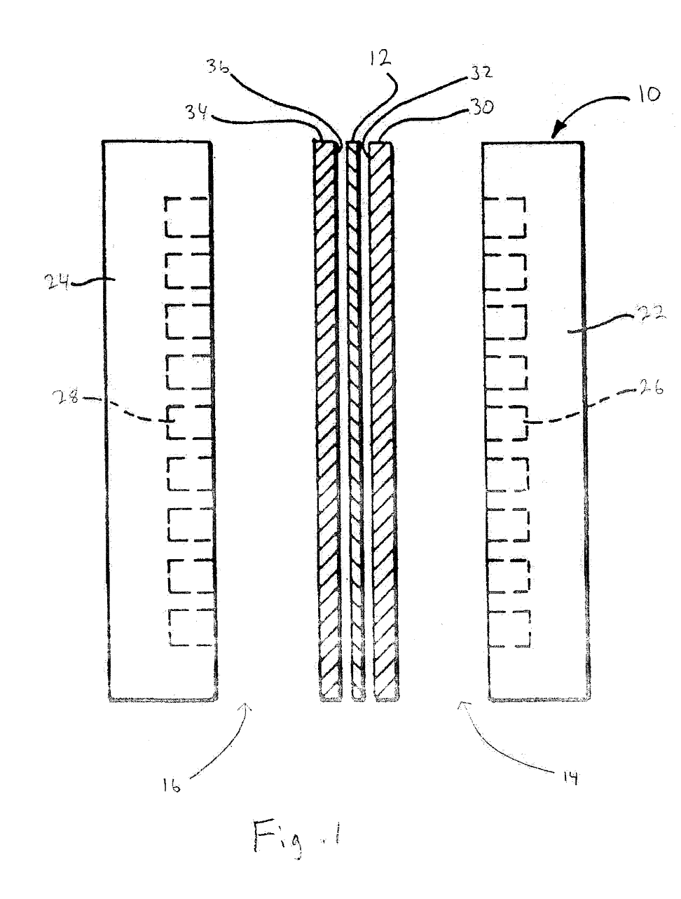

FIG. 1 illustrates a PEM fuel cell 10 having a membrane electrode assembly (“MEA”) 12, which separates the fuel cell 10 into a fuel side (“anode”) 14 and an oxygen side (“cathode”) 16. Typically, MEA 12 includes an ion exchange membrane, as described herein, sandwiched between two catalysts layers, one on each side of the membrane. The polymer membrane of membrane assembly 12 prohibits the electrons from passing through the membrane of MEA 12, but the protons are conducted through the polymer membrane to oxygen side 16 of fuel cell 10 and the electrons pass from the GDL 30 to the GDL 34 via an outer circuit (not shown), generating electricity. At the cathode side 16 of MEA 12, a reduction reaction occurs in which the protons, the oxygen, and electrons are combined to yield water. This reaction generally requires a catalyst, such as platinum or a platinum metal, described herein.

The catalyst may be located on the face of the membrane electrode assembly 12 with a separate catalyst for the anode side and the cathode side of fuel cell 10. This arrangement can be used in the present invention, if desired. The membrane 12 may be made in any conventional manner and of any conventional material used in PEM fuel cells. Typically, the membrane includes perfluorosulfonic acid-based polymers, available from DuPont under the trade name NAFION®, polytetrafluoroethylene (PTFE), or mixtures or copolymers thereof. Acid-doped polybenzimidazole (PBI) is another material that may be selected for the membrane material.

Gas-impermeable flow field plates 22 and 24 receive fuel or air (or other oxygen-containing gas) from sources outside fuel cell 10 and distribute these gases via flow channels 26 (for fuel side 14) and 28 (for oxygen side 16), respectively. Typically, the fuel side 14 receives the fuel and oxygen side 16 receives the air. Suitable fuels are a gas containing hydrogen (e.g., hydrogen or methanol for direct methanol fuel cells). Plates 22 and 24 may also provide structural support for the fuel cell as a whole and may also serve the function of current collector for conducting electrons to and from an external circuit (not shown). Fuel cells 10 may be stacked and the flow field plate 24 on the cathode side 16 for one fuel cell 10 could then function as the flow field plate 22 on the anode side 14 for the adjacent fuel cell 10, with the channels 26 present on one side and channels 28 present on the other side of the flow field plate.

Gas diffusion layers (“GDL”) 30 and 34 are provided on both sides of the fuel cell 10. In FIG. 1, GDL 30 is on the fuel side 14 and GDL 34 is on the oxygen side 16 . Typically, at least GDL 34 is constructed from flexible graphite. Typically, the flexible graphite comprise a compressed mass of expanded graphite particles in the form of a sheet having parallel, opposed first and second surfaces, at least a portion of the sheet having a plurality of transverse fluid channels passing through the sheet between the first and second parallel, opposed surfaces, the channels being formed by mechanically impacting the first surface of the sheet at a plurality of locations to provide the channels with openings at both of the first and second parallel, opposed surfaces. Preferable flexible graphite sheets are those commercially available under the names GRAFOIL® and GRAFCELL® from Graftech, Inc. The use of the term “flexible graphite sheets” is intended to refer to an article made of compressed, expanded (A.K.A. exfoliated) graphite either by itself or with one or more fillers or binders, wherein parallel surfaces of particles of graphite are oriented principally in a plane perpendicular to the “c” direction of the graphite particles and the thickness of the article in the direction parallel to the “c” direction is less than about 1.5 mm. Flexible graphite sheets are described in more detail by Shane et al. in U.S. Pat. No. 3,404,061, and by Mercuri, in U.S. Pat. No. 6,413,663 B1, the disclosures of which are incorporated herein by reference. Furthermore, GDL 34 and/or 30 may be resin impregnated or not resin impregnated. Optionally both GDLs 30 and 34 may be constructed from flexible graphite. Preferably, both the GDLs 30, 34 and the flow field plates 22, 24 are electrically conductive. Preferably, GDL 34 includes multiple paths or channels through which the gas (oxidant for GDL 34) may diffuse from the respective channels 28 through GDL 34 which GDL 34 increases the contact between the gas and the respective catalyst layer of membrane electrode assembly 12. The same is also preferred for GDL 30 with respect to the fuel and the fuel side 14 of fuel cell 10. Optionally, the gas diffusion layers may comprises any other material conventionally used for such gas diffusion layers, such as carbon cloth, in combination with such flexible graphite. Alternative, GDL 34 may be substantially free of carbon paper, carbon cloth, or carbon felt paper. The above description is equally applicable to GDL 30 for the anode side.

Typically, GDL 34 has a carbonaceous coating at an interface 36 between GDL 34 and MEA 12. Preferably, the carbonaceous coating is adhered to GDL 34 by the use of a hydrophobic polymeric binder (e.g., polyvinyldiene fluoride and/or polytetrafluoroethylene). More preferably, the binder comprises a generally fluorinated resin. Most preferably, the binder is soluble in an organic solvent (e.g., acetone). By soluble it is meant that the solubility of the binder in an organic solvent is greater than the solubility of polytetrafluoroethylene in the organic solvent. Suitable carbonaceous coatings may comprise graphite, carbon nanotubes, carbon fibers, graphite fibers, carbon black, activated carbon, Vulcan carbon, graphite nanofibers, carbon nanofibers, and combinations thereof. In one embodiment, typically the carbonaceous material is substantially devoid of soot.

Optionally, the binder may also include other compounds to adjust the hydrophobic nature of the binder as desired. For example, the binder may include non-hydrophobic compound (polyethylene glycol) and/or hydrophilic compounds (e.g., methyl carboxy cellulose).

In an embodiment of the present invention, the GDLs 30, 34 are electrodes. In other words, GDL 34 may also include a catalyst layer between the carbonaceous material on GDL 34 and membrane 12. In the case that GDL 34 also includes a catalyst layer, GDL 34 may be referred to as an electrode, preferably a cathode. Optionally, GDL 30 may also include a catalyst layer and form an electrode and function as an anode. In the case that the GDL is an electrode, MEA 12 may not have a catalyst layer on the side of the membrane facing the electrode.

At the anode 30, an oxidation reaction occurs in which hydrogen diffuses through the, preferably winding, pathways in the anode 30 until it encounters a catalyst. Typically, the catalyst is a platinum metal, which catalyzes the dissociation of the hydrogen molecule to two hydrogen atoms, which then release an electron to form a hydrogen ion (proton). Platinum metal includes platinum, rhodium, palladium, iridium, ruthenium, molybdenum, osmium, and combinations thereof. Catalysts of any material conventionally used in fuel cells may be used in the present invention, including transition metals. Alloys, which include a platinum metal, are also suitable catalysts. For example, typical catalysts in direct methanol fuel cells are platinum, ruthenium, molybdenum, or combinations thereof. In an embodiment of the present invention, the catalyst is located on the carbonaceous coating of GDL 34, at the interface36 between the GDL 34 and the membrane 12. Alternatively, the catalyst is mixed into carbonaceous material. The catalyst may also be present on the surfaces of the membrane 12, either exclusively or in parallel with the catalysts on the surfaces of the Gels 30, 34. Optionally the carbonaceous material may be applied to both the GDL 34 and/or 30 at the GDL's interface with the membrane assembly 12 and the GDL's interface with the flow field plates 22, 24, respectively (see FIG. 1).

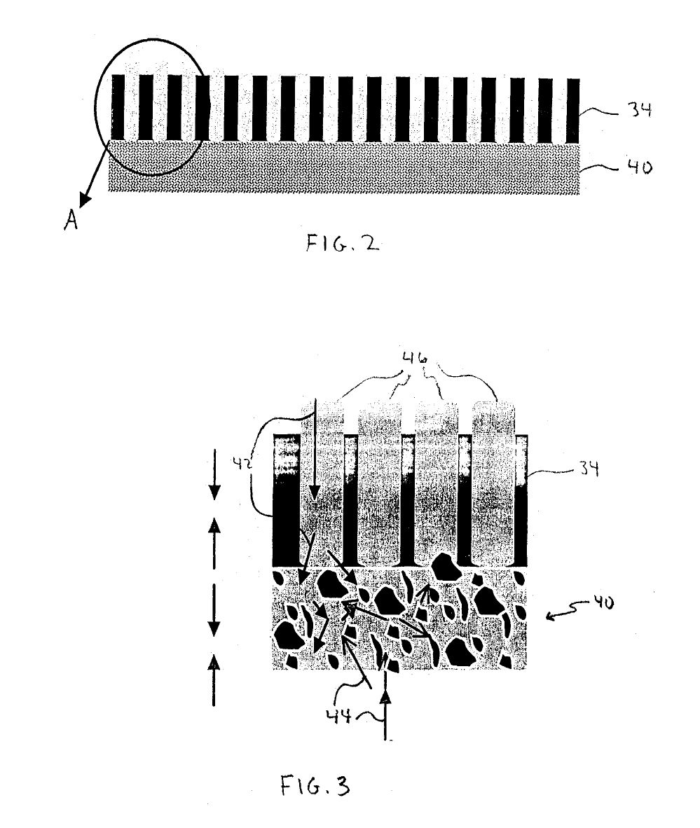

Adherence with the hydrophobic binder of carbonaceous materials to the GDLs 30, 34 has been found to provide a finer porosity and improved water management for the fuel cell 10. Porosity of the carbonaceous coating of between about 20% and about 80% is preferred. Without intending to be bound by any particular theory, it is believed that, as illustrated in FIGS. 2 and 3, the carbonaceous material coating 40 provides a network of porous structure to allow the incoming gas stream, identified with numeral 42, to have more flow paths available to reach the catalyst layer of MEA 12 and for the reaction product water, identified with numeral 44, to flow away from the reactions occurring at the catalyst.

As can best be seen in FIG. 3, a perforated flexible graphite electrode 34 typically has primarily unidirectional, single-phase diffusion through perforations 46 which can be obstructed or clogged if reaction product water droplets accumulate and join in the perforations 46. The carbonaceous coating 40 of the present invention, which is made with the carbonaceous material and the hydrophobic binder, provides many additional flow paths for the gas and the liquid to travel without interfering with each other. Moreover, selection of a hydrophobic binder having non-wetting characteristics for the water (or for the reaction product liquid, if not water) inhibits the water from accumulating on the surface of the carbonaceous material or on the surface of the perforations of the GDL and provides for more efficient removal of the water.

As discussed below, other materials may be added to the carbonaceous material coating 40 to increase or decrease the hydrophobicity or hydrophilicity of the coating 40, depending on the specific configuration of the fuel cell 10, available materials, or any other circumstance of the specific application. Appropriate additional material may be determined without undue experimentation without departing from the spirit or scope of the invention.

The carbonaceous material may be adhered to either one or both faces of GDLs 30, 34, but, typically, the carbonaceous material is adhered at least to interface 36 adjacent to MEA 12 on cathode side 16 to maximize contact with the water generated by the reaction combining hydrogen ions (protons) with oxygen to form the water reaction product. Further, the catalyst may be attached or dispersed in this layer of carbonaceous material that is adhered to the graphite sheet.

While any method to prepare carbonaceous material for adhesion to flexible graphite sheets and to accomplish this adhesion may be used, an example found particularly convenient is the use of a binder mixed with a solvent to which the carbonaceous material is added.

Typically, the binder for adhesion of the carbonaceous material to the GDL(s) 30, 34 is a hydrophobic polymeric binder, and preferably polyvinyldiene fluoride, also known as PVDF, polyvinyl difluoride, poly (vinylidene difluoride) and poly (1,1-difluoro-1,2-ethanediyl). PVDF may be obtained under the brand name Kynar® Flex® 2801 (a copolymer of PVDF and hexafluoro polypropylene available from ATOFINA Chemicals, Inc). Examples of other polymeric materials that can be used in combination with the hydrophobic binder to bind the carbonaceous material to the GDLs include perfluorosulfonic acid-based polymers, polytetrafluoroethylene (PTFE), or mixtures or coploymers thereof, available from DuPont under the trade names NAFION® or TEFLON®. Typically, the binder is present in concentration of between 1 to 35 weight % of the coating/binder mixture, and more typically between 5 to 20 weight %.

To apply the carbonaceous material to the GDL, the carbonaceous material may be combined with a solution having binder in one or more solvents and thoroughly mixed. Once the carbonaceous material is thoroughly mixed with the binder and solvent, the resulting mixture is applied to the GDL and the solvent is evaporated. The mixture may be applied by any conventional coating methods, such as roll coating, knife coating, spray coating, etc.

The solvent may be acetone, N-methyl-2-pyrrolidone (NMP), methanol, dimethyl formamide (DMF) isopropanol, water, mixtures, or solutions thereof, or any solvent that will serve to thoroughly mix the binder with the carbonaceous material for application to the electrode. Typically, the solvent is one that will dissolve the binder. The solvent may be selected based on the specific carbonaceous material used, the specific binder material selected, availability of materials, or preferences of the user. Typically the solvent is acetone. Once the solvent has evaporated, the resulting coated sheet may be sintered, pressed, or calendered to aid the binding of the material to the sheet. The term sintered is used herein to describe heating a material to above its melting point but to less than the decomposition temperature, and typically less than a temperature at which the viscosity of the material allows the material to flow like a liquid. Typically, sintering occurs at a temperature at which the binder fuses the flexible graphite and adheres the carbonaceous material to the flexible graphite. Depending on circumstances, availability of materials and facilities, preferences of the user, and other factors, the specific materials, concentrations of the binder, solvent, and carbonaceous material, the temperatures, times, and other parameters of the evaporation and sintering all may be varied without undue experimentation regarding the effectiveness of the variations. The carbonaceous material may be adhered to the perforated flexible graphite sheet either before or after it is perforated, if the sheet is to be perforated.

It may be advantageous for particular applications to apply a first coating to the GDL 30, 34 using one binder, for example, PVDF, and then apply a second coating of different thickness on top of the first coating with a second binder, for example PTFE. This would provide variation in the wettability of the carbonaceous material coating 40. Alternatively, the sheet may be heat treated prior to the application of the carbonaceous material to the sheet.

The invention may also include adhering graphite powder onto the flexible graphite sheet. Typically, the graphite powder may comprise up to about 200 microns, more typically up to about 100 microns. Suitable graphite powder also includes sub-micron sized particles. The graphite powder may be formed from natural graphite, synthetic graphite, or expanded graphite. The graphite powder may be located in one or more of various locations, such as on a surface of GDL 30 or 34 facing MEA 12, at one or both of interfaces 36 or 34, or either one or both of the catalyst layers of MEA 12. The presence of the graphite powder in the inventive article will reduce the contact resistance between electrode 30 or 34 and the adjacent catalyst of MEA 12.

Among other things, the invention as herein described provides improved electrodes or gas diffusion layers for use in fuel cells. The electrodes or gas diffusion layers need not be perforated flexible graphite sheets, but perforated flexible graphite sheets are preferred. The fuel cells need not be PEM fuel cells, and the invention is applicable to a variety of fuel cell and other applications in which there is an electrode or a gas diffusion layer, particularly for water and gas removal and flow management. The processes of adhering carbonaceous material to a flexible graphite sheet described herein may be particularly cost effective mass production manufacturing methods.

The invention will be further clarified by the following examples. In the examples, all percentages are percent by weight unless stated otherwise.

### EXAMPLE 1

A solution of 7 grams of activated carbon (NUCHAR® SA-20) was added to a stirring solution of 1 gram of PVDF (KYNAR® FLEX® 2801) in about 25 ml of acetone. After about 15 minutes of stirring, the mixture (which has about 12.5% binder and about 87.5% carbon, not including the solvent) was applied to GRAFOIL® substrates that were non-perforated. The acetone was evaporated in a hood, and then the composite was placed in an oven at about 110° C. to drive off any residual acetone. After removal of the solvent, the composite was sintered at about 200° C. for about 20 minutes. The composite was then perforated, using a mechanical impact perforation procedure. The above procedure was repeated to produce five (5) samples for testing.

The resulting composite materials exhibited suitable flexibility and the carbonaceous material adhered well to the flexible graphite sheet at thicknesses of the applied carbonaceous material equal to or less than about 0.005 inches. The samples were able to be bent without observing any cracking or flaking of the coating. With respect to adherence, the coating did not delaminate at the binder graphite interface, typically, delamination would occur internally within the flexible graphite substrate.

### EXAMPLE 2

The materials and procedure set forth in Example 1 were repeated, except that the substrate to which the mixture was applied was a perforated flexible graphite sheet. Again, the composite exhibited suitable flexibility and adherence, as described in Example 1, of the carbonaceous layer at thicknesses of the applied carbonaceous material equal to or less than about 0.005 inches.

### EXAMPLE 3

5 grams of Vulcan carbon were added to a 60% PTFE solution, thereby forming a solution having a 20-30% final concentration of PTFE. Isopropanol alcohol was added to the solution and stirred to adjust the viscosity of the solution to form a slurry, such that the slurry could be sprayed onto the substrate. The slurry was applied to the surface of a perforated graphite sheet, by spraying, and the sheet was dried at 115° C. in an oven for about 2 hours and subsequently heated in an oven at a temperature of about 333° C. for about 30 minutes to form the final product. The coating adequately adhered to the substrate; to remove the coating scraping of the coated surface of the substrate was required.

### EXAMPLE 4

In this example, the procedure described regarding Example 3 was repeated with an additional 2.5 grams of exfoliated graphite powder added to the PTFE solution. The coating exhibited substantially the same adherence, as did the coating in Example 3.

### EXAMPLE 5

In this example, samples were made in accordance with Example 3 and Examples 4. The Vulcan carbon-PTFE layers were coated with a thin layer of an 85-95% carbon black and 5-15% Nafion mixture by means of spraying or knife-coating, and heat treated at 90° C. for 15 minutes. It was observed that the coated samples of Example 5 exhibited better adherence than in Examples 3 and 4. The necessary pressure to scrape the coated surface to remove the coating was greater than the necessary pressure to remove the coatings of Examples 3 and 4.

### EXAMPLE 6

1 gram of expanded graphite powder was added to 0.2 grams of PVDF in an acetone solution, and the solution was mixed together. The resulting viscous liquid was applied to a perforated GRAFOIL® sheet, forming a 100 micron thick layer on the sheet. The coated sheet was dried in an oven at 85° C. overnight. The adhesion o f the coating to the substrate was similar to the adhesion disclosed in Examples 1 and 2 and greater the adherence in the coatings associated with Examples 3-5.

### EXAMPLE 7

In this example, the procedure in Example 6 was repeated with the addition of polypropylene glycol, as plasticizer, to the PVDF acetone solution noted above. The coating of Example 7 exhibited similar adherence to the coating of Example 6.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

While the present invention has been illustrated by the above description of embodiments, and while the embodiments have been described in some detail, it is not the intention of the Inventors to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the Inventors' general or inventive concept.

What is claimed is:

1. A graphite article comprising:
a. a compressed mass of expanded graphite particles in the form of a sheet having opposed major surfaces,
b. a hydrophobic polymeric binder on one of said major surfaces, and
c. a carbonaceous material in contact with said polymeric binder on said one major surface.

2. The graphite article of claim 1, wherein the carbonaceous material comprises at least one material selected from the group consisting of: graphite, carbon nanotubes, carbon fibers, graphite fibers, carbon nanofibers, graphite nanofibers, carbon black, activated carbon, and combinations thereof.

3. The graphite article of claim 1, wherein said hydrophobic polymeric binder comprises at least a fluorinated compound.

4. The graphite article of claim 1, wherein the binder comprises polyvinyldiene fluoride, and further comprises at least one material selected from the group consisting of perfluorosulfonic acid-based polymer, polytetrafluoroethylene, or copolymers thereof.

5. The graphite article of claim 1 wherein said hydrophobic polymeric. binder further comprises a hydrophilic compound.

6. The graphite article of claim 1 further comprising a catalyst layer adjacent to said carbonaceous material adhered to said one major surface of said sheet.

7. The graphite article of claim 1, further comprising a graphite powder adhered to said one major surface.

8. The graphite article of claim 7, wherein a precursor of said graphite powder comprises exfoliated graphite.

9. The graphite article of claim 1, further comprising a catalyst dispersed in said carbonaceous material.

10. The graphite article of claim 1, wherein said flexible graphite sheet further comprises a plurality of perforations.

11. The graphite article of claim 10, wherein said flexible graphite sheet further comprises at least one non-perforated region.

12. The graphite article according to claim 1, wherein said sheet further comprises at least one perforated region and at least one non-perforated region around a perimeter of said sheet, wherein said binder comprises polyvinyldienefluoride, and said carbonaceous material comprises at least one of graphite, carbon nanotubes, carbon fibers, graphite fibers, and combinations thereof.

13. The graphite article of claim 1, wherein said sheet comprises a plurality of channels between said one major surface and a second surface of said opposed major surfaces for fluid to flow from said one major surface to said second major surface.

14. The graphite article of claim 1 wherein said hydrophobic binder comprises a compound soluble in an organic solvent.

15. A method of making a flexible graphite sheet for use in a fuel cell, comprising
a. adding carbonaceous material to a hydrophobic polymeric binder to form a mixture;
b. applying the mixture to a major surface of a flexible graphite substrate; and
c. sintering the flexible graphite substrate having the applied mixture to yield a flexible graphite sheet having adhered carbonaceous material.

16. The method of claim 15 further comprising perforating the flexible graphite substrate before applying the mixture thereto.

17. The method of claim 15 further comprising perforating the flexible graphite substrate after applying the mixture thereto.

18. The method of claim 15 further comprising adhering a graphite powder to said major surface of said sheet.

19. The method of claim 15 further comprising dispersing a catalyst in said mixture.

20. The method according to claim 15 further comprising adding a hydrophilic compound to said mixture.
